(19) United States
(12) Patent Application Publication
(10) Pub. No.: US 2021/0157746 A1
(43) Pub. Date: May 27, 2021

(54) KEY-VALUE STORAGE DEVICE AND SYSTEM INCLUDING THE SAME

(71) Applicants: SK hynix Inc., Gyeonggi-do (KR); Sogang University Research and Business Development Foundation, Seoul (KR)

(72) Inventors: Changgyu LEE, Seoul (KR); Youngjae KIM, Seoul (KR); Jung Ki NOH, Gyeonggi-do (KR); Woo Suk CHUNG, Gyeonggi-do (KR); Kyoung PARK, Gyeonggi-do (KR)

(21) Appl. No.: 16/923,975

(22) Filed: Jul. 8, 2020

(30) Foreign Application Priority Data
Nov. 25, 2019 (KR) 10-2019-0152483

(51) Int. Cl. G06F 12/14; G06F 12/0891; G06F 12/0882; G06F 12/0817; G06F 12/02; G06F 21/79

(52) U.S. Cl. CPC G06F 12/1466; G06F 12/0891; G06F 12/0882; G06F 2221/0751; G06F 12/0253; G06F 21/79; G06F 2212/7201; G06F 12/0824

(57) ABSTRACT

A data storage device includes a nonvolatile memory device including a key storage area and a value storage area; and a first control circuit configured to control storing a value in the value storage area, and storing a key corresponding to the value with address information of a value in the key storage area according to a key-value (KV) command.

### CROSS-REFERENCE TO RELATED APPLICATION

The present application claims priority under 35 U.S.C. § 119(a) to Korean Patent Application No. 10-2019-0152483, filed on Nov. 25, 2019, which is incorporated herein by reference in its entirety.

### BACKGROUND

### 1. Technical Field

Various embodiments generally relate to a key-value storage device and a system including the key-value storage device.

### 2. Related Art

Because a conventional data storage device processes data and commands in units of blocks, there is a problem that it cannot directly process key-value (KV) commands.

In a conventional system, a KV command is converted into a block-based command according to a file system operated by a host and provided to a data storage device to perform a KV data processing operation.

Accordingly, when a host processes a KV application program, the host needs to convert a KV command provided by the application into a block-based command, thereby limiting processing performance.

In addition, because keys in KV commands and data or values corresponding to the keys must be managed according to the file system operated by the host, data storage space is wasted when a key and a value use less space than a file.

### SUMMARY

In accordance with an embodiment of the present disclosure, a data storage device may include a nonvolatile memory device including a key storage area and a value storage area; and a first control circuit configured to control storing a value in the value storage area, and storing a key corresponding to a value with address information of the stored value in the key storage area according to a key-value (KV) command.

In accordance with an embodiment of the present disclosure, a system may include a host configured to generate a key-value (KV) command; a data storage device configured to perform a read or a write operation according to the KV command; and an interface circuit configured to transfer the KV command between the host and the data storage device, wherein the data storage device may include a nonvolatile memory device including a key storage area and a value storage area; and a first control circuit configured to control storing a value in the value storage area, and storing a key corresponding to a value with address information of the value in the key storage area according to the KV command.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 shows a block diagram illustrating a system according to an embodiment of the present disclosure.

FIGS. 2A to 2C show structures of key-value (KV) commands according to an embodiment of the present disclosure.

FIG. 3 shows a block diagram illustrating a data storage device according to an embodiment of the present disclosure.

FIG. 4 shows a data structure of a second table according to an embodiment of the present disclosure.

FIG. 5 shows data structures of a value log area and a log entry according to an embodiment of the present disclosure.

FIG. 6 shows a diagram illustrating an operation of processing a PUT command in a data storage device according to an embodiment of the present disclosure.

FIG. 7 shows a diagram illustrating an operation of processing a GET command in a data storage device according to an embodiment of the present disclosure.

FIG. 8 shows a diagram illustrating an operation of processing a DELETE command in a data storage device according to an embodiment of the present disclosure.

FIGS. 9A and 9B show diagrams illustrating a log cleaning operation in a data storage device according to an embodiment of the present disclosure.

FIGS. 10A and 10B show diagrams illustrating a distributed logging operation in a data storage device according to an embodiment of the present disclosure.

FIG. 11 shows a diagram illustrating a distributed logging linked list in a data storage device according to an embodiment of the present disclosure.

FIG. 12 shows a block diagram illustrating a data storage device according to an embodiment of the present disclosure.

FIGS. 13A and 13B show structures of KV commands for a near data processing according to an embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of the present teachings. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

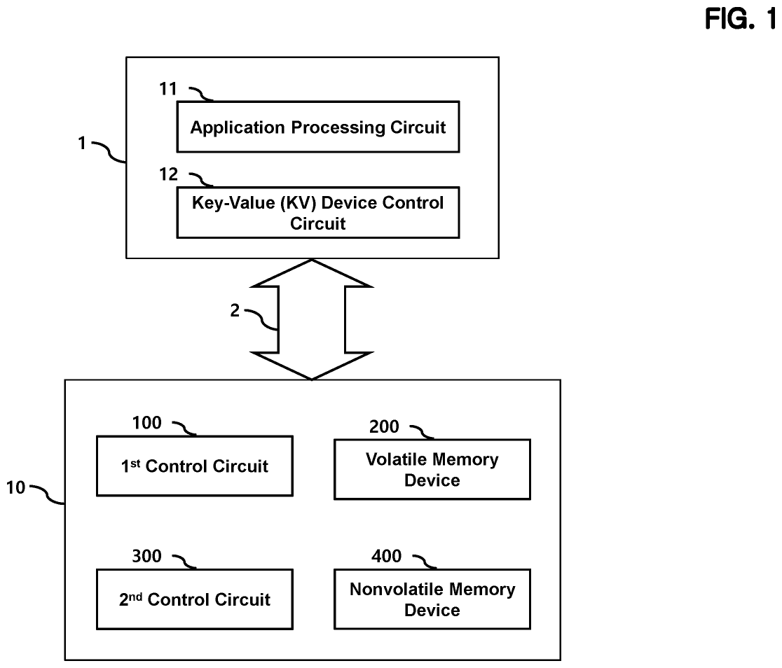

FIG. 1 is a block diagram of a system according to an embodiment of the present disclosure.

The system according to an embodiment of the present disclosure includes a host 1, an interface circuit 2, and a data storage device 10.

The interface circuit 2 may be implemented with hardware, software, or combination thereof that operate to transmit and receive key-value (KV) commands and data between the host 1 and the data storage device 10. The data represents a value corresponding to a key included in a KV command.

In this embodiment, the interface circuit 2 conforms to, but is not limited to, the PCI Express (PCIe) standard.

The data storage device 10 receives a KV command and accordingly performs a KV-based data read/write operation.

The data storage device 10 includes a first control circuit 100, a volatile memory device 200, a second control circuit 300, and a nonvolatile memory device 400.

The first control circuit 100 may manage a data structure for processing KV commands.

The first control circuit 100 may control the volatile memory device 200, the second control circuit 300, and the nonvolatile memory device 400 to process KV commands.

In this embodiment, the volatile memory device 200 includes a Dynamic Random Access Memory (DRAM), but is not limited thereto.

Also, in the present embodiment, the nonvolatile memory device 400 includes, but is not limited to, a NAND flash memory.

Also, in the present embodiment, the second control circuit 300 controls operations of reading or writing data to the nonvolatile memory device 400.

For example, the second control circuit 300 may correspond to a Flash Translation Layer (FTL) in a conventional solid state drive (SSD), may manage a mapping table, and may control a garbage collection operation.

The host 1 generates a KV command according to a KV request generated during an operation of processing a system program or an application program, and provides the KV command to the data storage device 10 through the interface circuit 2.

The host 1 may include hardware, software, or a combination thereof, which processes an operation of an application program.

The host 1 includes an application processing circuit 11 and a KV device control circuit 12.

The application processing circuit 11 may be comprised of hardware, software, or a combination thereof for processing an application program.

The application program may be compiled with an API library supporting KV processing and be converted into machine codes, and the application processing circuit 11 can process the compiled machine codes.

The API library for KV processing can support KV requests such as GET, PUT, and DELETE requests.

In this case, the GET request corresponds to a read operation, the PUT request to a write operation, and the DELETE request to a delete or erase operation.

The KV device control circuit 12 generates a KV command corresponding to a KV request from the application processing circuit 11 and provides the KV command to the interface circuit 2.

In the embodiment, the data storage device 10 using a nonvolatile memory device is coupled via the interface circuit 2 conforming to the PCI Express (PCIe) standard.

Accordingly, in the present embodiment, the KV device control circuit 12 may generate a KV command that conforms to the Nonvolatile Memory Express (NVM Express) protocol.

In addition, the KV device control circuit 12 may generate a PCIe command including the generated KV command and provide the PCIe command to the interface circuit 2 so that the KV command is transmitted to the data storage device 10.

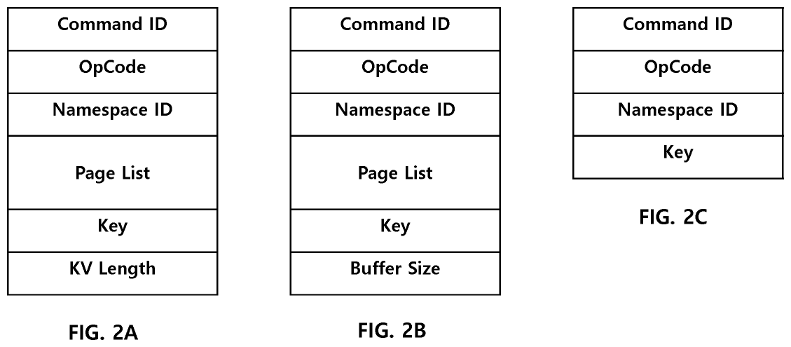

FIGS. 2A to 2C show structures of KV commands according to an embodiment of the present disclosure.

In the embodiment, a KV command may be viewed as an extension of an NVMe command.

FIG. 2A corresponds to a PUT command, FIG. 2B corresponds to a GET command, and FIG. 2C corresponds to a DELETE command.

As aforementioned, a PUT command corresponds to a write operation, a GET command corresponds to a read operation, and a DELETE command corresponds to an erase or a delete operation.

In FIGS. 2A to 2C, CommandID and NamespaceID fields are present in the NVMe protocol and represent an identification of a KV command transmitted from a host and a recipient of the KV command, respectively.

The other fields correspond to redefining of OpCode, LBA start address, and reservation space present in the NVMe protocol for KV commands.

The other fields have the following meanings.

The OpCode field represents an operation to be performed by a device receiving a corresponding command.

The PageList field represents a list of memory page addresses to store data when transmitted or received by the host 1.

The Key field represents a key that is a target for performing a KV command.

The KV Length field represents a total length of data to be stored.

The Buffer Size field represents a size of a memory allocated by the host 1 to store a value to be received by the host 1 when executing a GET command.

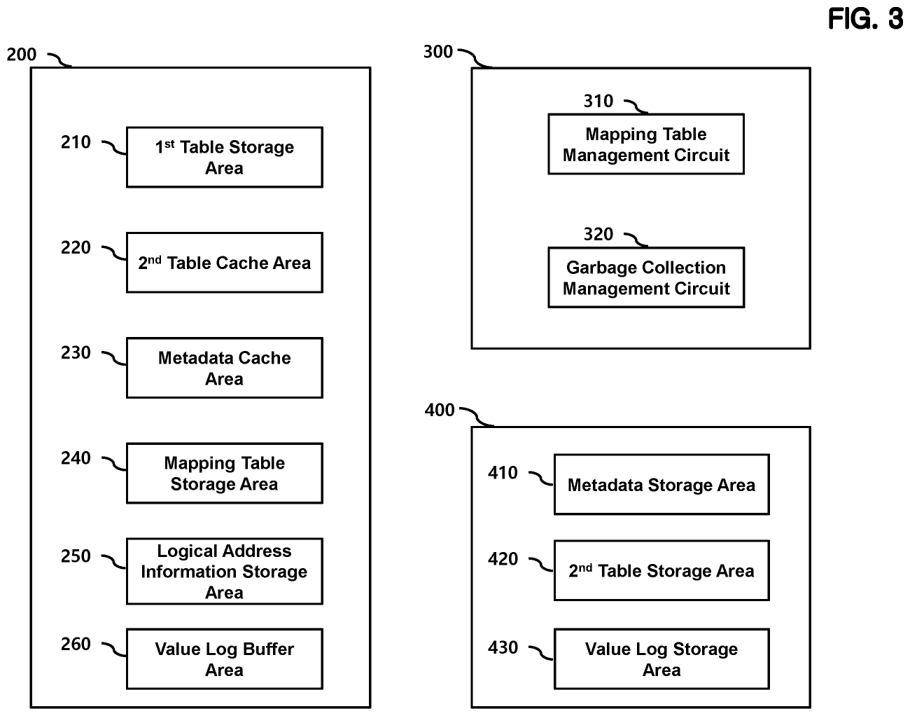

FIG. 3 is a block diagram illustrating a data storage device 10 according to an embodiment of the present disclosure.

In this embodiment, the data storage device 10 includes a first control circuit 100 to process a KV command transmitted from the interface circuit 2 and the first control circuit 100 controls the volatile memory device 200, the second control circuit 300, and the nonvolatile memory device 400.

In the embodiment, the first control circuit 100 interprets a KV command to generate a read/write command for a logical address and controls the volatile memory device 200, the second control circuit 300, and the nonvolatile memory device 400 for a read/write operation, where the read/write operation itself is substantially the same as that performed in a conventional SSD.

In this embodiment, the first control circuit 100 distinguishes a key from a value and manages them separately to process a KV command.

The first control circuit 100 uses a data structure to manage keys. In the present embodiment, an LSM tree (Log-Structured Merge Tree) is used.

The LSM tree is a data structure for retrieving a key using a first table and a second table.

The first table and the second table basically store a key and a value log offset. The value log offset corresponds to address information used to determine an address where a value corresponding to the key is stored.

Separately, the first control circuit 100 manages a value log area 430 for storing the value.

The volatile memory device 200 includes a first table storage area 210, a second table cache area 220, a metadata cache area 230, a mapping table storage area 240, a logical address information storage area 250, and a value log buffer area 260.

The first table storage area 210 is an area in which the first table used in the LSM tree is stored.

The second table cache area 220 is an area for temporarily storing the second table generated from the first table.

Accordingly, the first table may have substantially the same data structure as the second table.

Data structure of a second table is described in detail below.

The metadata storage area 230 is an area that caches the metadata storage area 410 included in the nonvolatile memory device 400.

Information stored in the metadata storage area 410 is described in detail below.

The mapping table storage area 240 is an area for storing a mapping table managing relationships between logical addresses and physical addresses.

In this embodiment, it is assumed that mapping is between logical page addresses and physical page addresses, but the present invention is not limited thereto. Hereinafter, a logical address may be referred to as a logical page address and a physical address as a physical page address.

The logical address information storage area 250 stores addresses (or information indicative of addresses), where the addresses (or information indicative thereof) are divided or grouped into sections, each of which includes a subset of all addresses.

In this embodiment, all logical addresses are divided into a metadata storage section, a second table storage section, and a value log storage section.

These correspond to the metadata storage area 410, the second table storage area 420, and the value log storage area 430 included in the nonvolatile memory device 400, respectively.

In this embodiment, a size of each storage area may be determined in advance with reference to maximum number of second tables, sizes of keys and values, etc. that the system can accommodate.

The logical address information storage area 250 may store addresses (or information indicative thereof) of the metadata storage section, the second table storage section, and the value log storage section.

The value log buffer area 260 is a space for temporarily storing a value provided through the interface circuit 2.

The volatile memory device 200 may include one or more memory chips, and accordingly, the first table storage area 210, the second table cache area 220, the metadata cache area 230, the mapping table storage area 240, the logical address information storage area 250 and the value log buffer area 260 may be stored in one memory chip or may be stored in different memory chips distributed in various ways.

The first control circuit 100 may perform operations such as adding or updating information by accessing each area of the volatile memory device 200 whiling processing a KV command.

Specific processing operation for a KV command is described in detail below.

The second control circuit 300 includes a mapping table management circuit 310 and a garbage collection management circuit 320.

The mapping table management circuit 310 manages a relationship between logical addresses and physical addresses stored in the mapping table storage area 240.

The garbage collection management circuit 320 manages a garbage collection operation, where valid page data may be relocated and a relationship between logical addresses and physical addresses may be updated.

The nonvolatile memory device 400 includes a metadata storage area 410, a second table storage area 420, and a value log storage area 430. The second table storage area 420 may be referred to as a key storage area and the value log storage area 430 may be referred to as a value storage area.

The second table storage area 420 is an area for managing keys. Also, the second table storage area 420 stores the second table according to the LSM tree scheme in this embodiment.

When a first table stored in the first table storage area 210 is flushed, and the flushed first table is temporarily stored as a second table in the second table cache area 220 and then stored in the second table storage area 420.

In this embodiment, the first table storage area 210 of the volatile memory device 200 and the second table storage area 420 of the nonvolatile memory device 400 may be used together to manage keys.

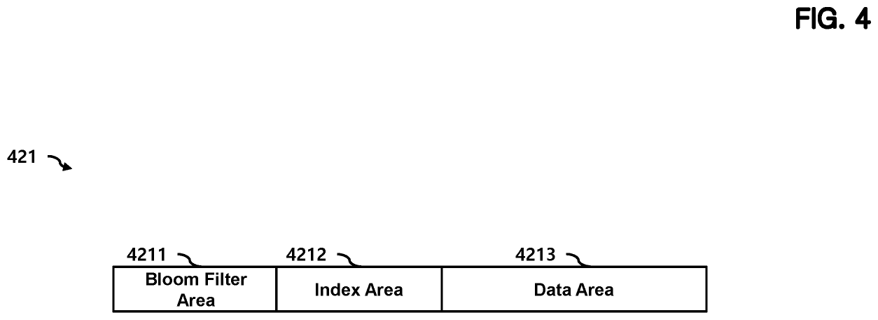

FIG. 4 shows a data structure of the second table 421 according to an embodiment of the present disclosure.

The second table 421 includes a bloom filter area 4211, an index area 4212, and a data area 4213, and each area includes a plurality of pages and are arranged in units of pages.

The bloom filter area 4211 stores filter data corresponding to a bloom filter. The filter data may be generated from hash data for keys stored therein. The first control circuit 100 may use the filter data to determine whether a key is included in the second table 421.

The index area 4212 stores a plurality of key-offset pairs each including a key and an offset. An offset is used to find a value log offset corresponding to a key in the data area 4213.

The plurality of key-offset pairs included in the index area 4212 may be stored in a list arranged in order of magnitude of keys, and in this case, a binary search may be performed to quickly find a particular key-offset pair.

The data area 4213 stores a plurality of value log offsets in the form of a list. Each value log offset represents an address where a value corresponding to a key is stored. In other embodiments, the index area 4212 may store a plurality of keys instead of key-offset pairs. Then the plurality of value log offsets should be arranged in the order of corresponding keys stored in the index area 4212. For example, a first key in the index area 4212 corresponds to a first value log offset in the data area 4213.

The first control circuit 100 determines whether a key corresponding to a KV command exists in the index area 4212 in a “false positive” way using the filter data in the bloom filter area 4211.

For example, when it is determined by the first control circuit 100 that the key corresponding to the KV command does not exist, that key does not exist in the index area 4212, and when it is determined by the first control circuit 100 that such key exists, it is necessary to search for that key in the index area 4212.

When the target key is found in the index area 4212, a data area 4213 can be searched using an offset paired with the key to retrieve corresponding value log offset.

The value log area 430 is an area that stores values corresponding to keys. The key and the corresponding value are logically coupled to each other through the value log offset stored in the data area 4213 and the offset stored together with the key in the index area 4212.

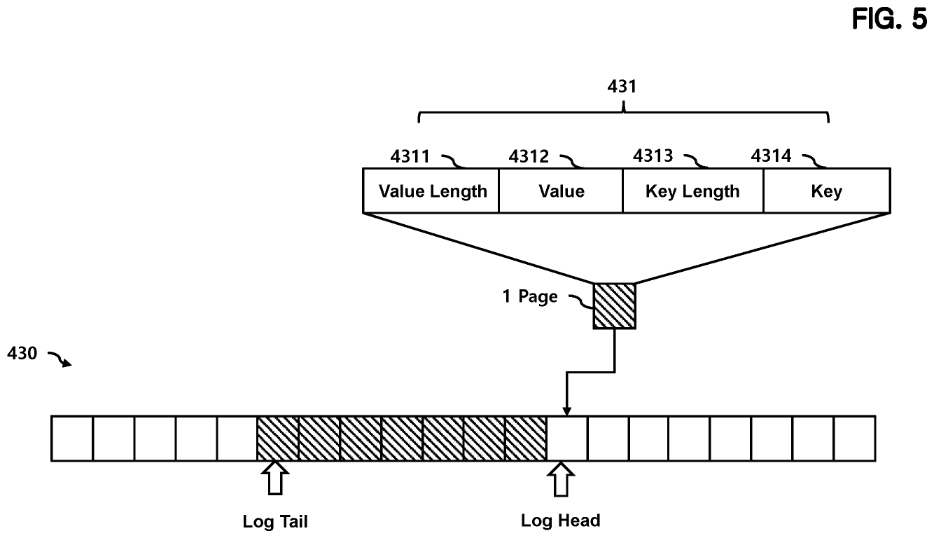

FIG. 5 shows a data structure of the value log area 430 according to an embodiment of the present disclosure.

The value log area 430 stores a log entry 431 using a log tail pointer and a log head pointer.

The log tail pointer indicates a location where a log entry was stored first, and the log head pointer indicates a location where a log entry 431 will be stored. The log head pointer and the log tail pointer may be represented as logical addresses. Then, physical addresses corresponding to the log head pointer and the log tail pointer may be determined from the mapping table stored in the mapping table storage area 230.

A log entry 431 is stored at a location indicated by the log head pointer, and then the log head pointer moves to a next empty location so that another log entry can be added.

A log entry 431 includes a value length area 4311 and a value area 4312.

The value length area 4311 stores length of a value, and the value area 4312 stores a value.

In this embodiment, a log entry 431 is sufficient to store value information, but key information may be additionally stored therein.

To additionally store key information, a key length area 4313 and a key area 4314 may be additionally included in a log entry 431.

The key length area 4313 stores length of a key, and the key area 4314 stores a key itself.

A log entry 431 may be formed to include one or more pages and then added to a location pointed to by the log head pointer.

Referring back to FIG. 3, the metadata storage area 410 may store metadata for the second table 421, a log head pointer, and the like.

The metadata for the second table 421 includes an ID of the second table 421, maximum and minimum keys among keys in the second table 421, starting logical address of the second table 421, number of pages for the bloom filter area 4211, a number of pages for the index area 4212, and number of pages for the data area 4213.

In this embodiment, an LSM tree may be implemented with a multi-level list structure storing a plurality of second tables 421.

Accordingly, as metadata for the multi-level list structure, a head pointer for the entire list and a head pointer for each level may be included.

The log head pointer includes a second table log head pointer and a value log head pointer.

The second table log head pointer may include a logical address for the second table 421 to be additionally stored in the second table storage area 420 and a start logical address and a last logical address of the second table storage area 420.

The value log head pointer may include a logical address for the log entry 431 to be additionally stored in the value log area 430 and a start logical address and a last logical address of the value log area 430.

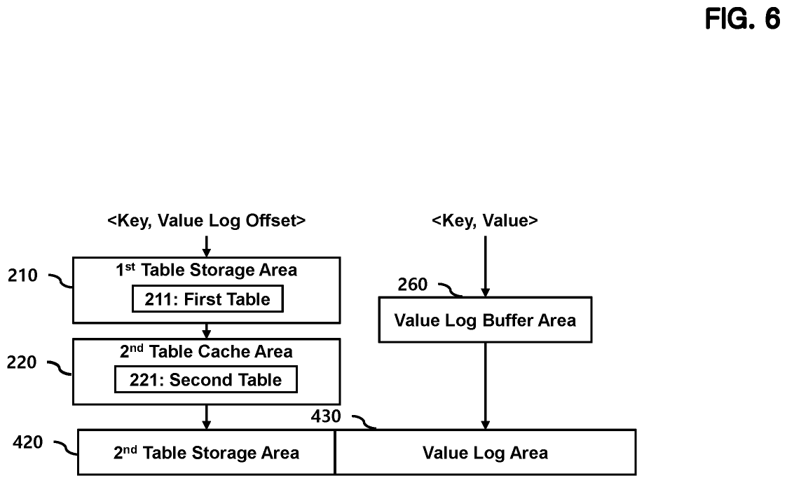

FIG. 6 is a diagram illustrating an operation of processing a PUT command in the first control circuit 100 according to an embodiment of the present disclosure.

When a PUT command is input, the first control circuit 100 extracts a key from a PUT command, and manages key information using the first table 211 stored in the first table storage area 210 and the second table 221 stored in the second table cache area 220, and stores data or value corresponding to the PUT command in the value log storage area 430. The data or value may be stored in the value log buffer area 260 before it is stored in the value log storage area 430.

Conventionally, a key and a value are managed using a file system supported by a host operating system within the host 1 and they are stored in one or more files, thus requiring data storage space that could be used for other purposes. Thus, data storage space is wasted.

In the present embodiment, data storage space is not wasted because a key and a value are stored in one or more pages instead of files.

The first control circuit 100 creates the log entry 431 using a key and a value and adds the log entry 431 into to the value log area 430.

The first control circuit 100 may determine a value log offset corresponding to a location where a value log entry 431 is added by referring to a value log head pointer.

A value log head pointer is determined by referring to the metadata cache area 230.

The first control circuit 100 stores a key and a corresponding value log offset in the first table 211 in the first table storage area 210.

When the first table 211 is full, the first table 211 is flushed to generate the second table 221, which is added to the second table storage area 420.

The operation of adding the second table 221 to the second table storage area 420 is performed according to the LSM tree structure.

The operation of adding a second table according to the LSM tree structure is well-known, so detailed description thereof is omitted.

Storing the second table 221 in the second table storage area 420 and storing the log entry 431 in the value log area 430 are performed by a writing operation controlled by the first control circuit 100. The mapping table stored in the volatile memory device 200 and the second control circuit 300 may be controlled by the first control circuit 100. The write operation itself is substantially the same as that performed in a conventional SSD.

As those skilled in the art understand, metadata such as a value log head pointer is changed according to the PUT operation, and thus information in the metadata storage area 410 and the metadata cache area 230 should be updated. Accordingly, description thereof is omitted.

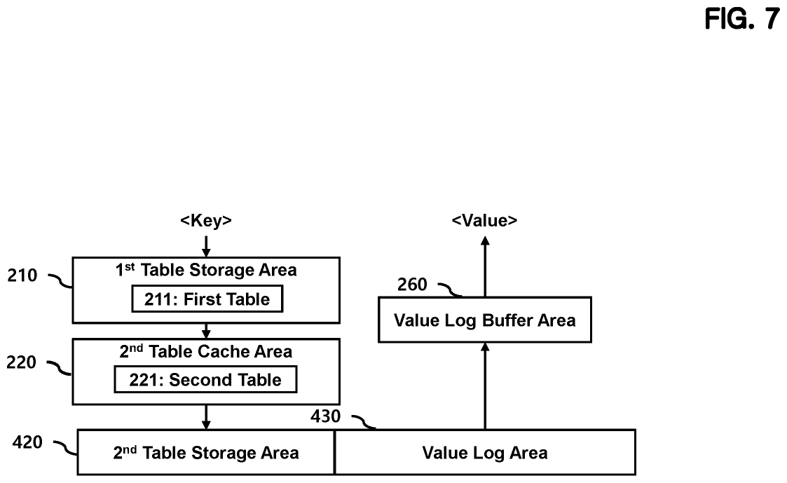

FIG. 7 is a diagram illustrating an operation of processing a GET command in the first control circuit 100 according to an embodiment of the present disclosure.

A GET command corresponds to a read command. While processing a GET command, it is determined whether a key included in a GET command exists in the first table 211 stored in the first table storage area 210.

When a key does not exist in the first table storage area 210, the second table storage area 420 is further searched to determine whether a key included in a GET command exists therein.

Determining whether a key exists in either/both of the two table storage areas can be performed using a key in the GET command and the bloom filter stored in the bloom filter area 4211. When it is determined by the bloom filter that the key in the GET command exists, that determination is finally indicated in the index area 4212.

When the GET command key exists, the value log offset corresponding to the key is found, and the value corresponding to the key is read from the value log area 430 based on the found value log offset and output via the value log buffer area 260.

At this time, reading a value log offset from the second table storage area 420 or reading a value from the value log area 430 is performed by a read operation controlled by the first control circuit 100. The mapping table stored in the volatile memory device 200 and the second control circuit 300 may be controlled by the first control circuit 100. The read operation itself is substantially the same as that performed in a conventional SSD.

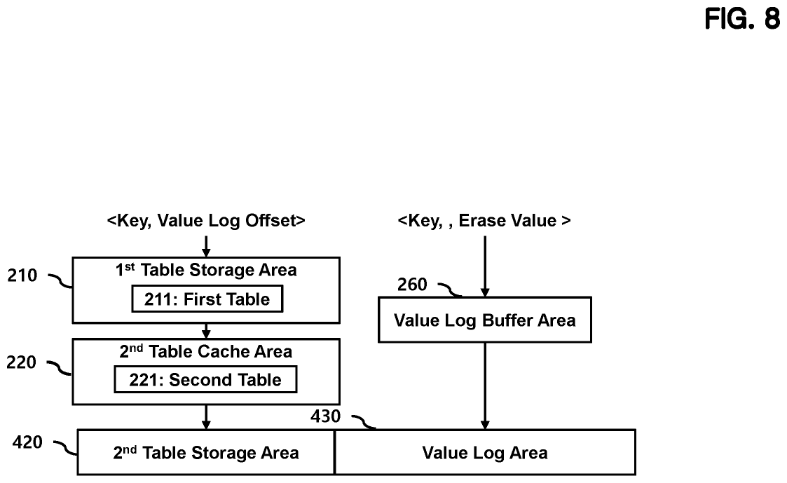

FIG. 8 is a diagram illustrating an operation of processing a DELETE command in the first control circuit 100 according to an embodiment of the present disclosure.

In this embodiment, processing a DELETE command is substantially the same as processing a PUT command.

While a value is stored by a PUT command is actual data to be written corresponding to a key, a value stored by a DELETE command is flag data indicating that a key has been deleted.

Accordingly, detailed description of an operation of a DELETE command is not repeated.

Even if a DELETE command is executed, previously stored key and value may remain.

Therefore, for example, when a stored key remains in the second table storage area 420, a stored value log offset corresponding to the stored key is found, and a stored value in the value log area 430 is invalidated, and then the stored value log offset is invalidated.

If a space in the value log area 430 becomes invalid, the storage space becomes insufficient, so that a log cleaning operation can be performed.

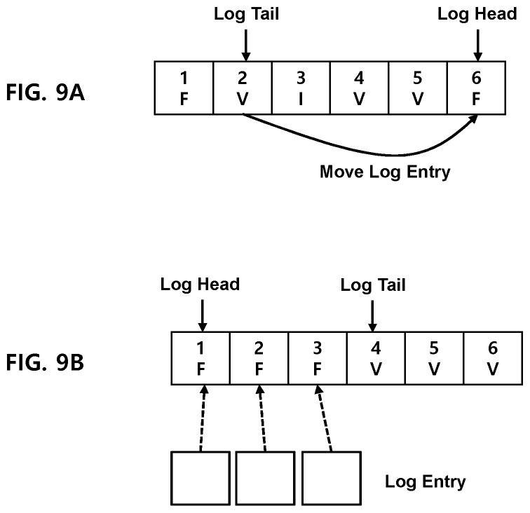

FIGS. 9A and 9B are diagrams for explaining a log cleaning operation according to an embodiment of the present disclosure.

In FIGS. 9A and 9B, numbers represent logical addresses, F represents a free page, I represent an invalid page, and V represents a valid page.

During a log cleaning operation valid pages are moved like a garbage collection operation, so that invalid pages are in the same block.

FIG. 9A shows how a valid page at the logical address 2 moves to a free logical address 6 indicated by the log head pointer.

Thereafter, a block may be erased to generate free pages at logical addresses 1, 2, and 3.

A log entry can be added at the free logical address.

In the log cleaning process, the log tail pointer is updated to indicate the logical address 4, where the oldest valid page is stored, and the log head pointer is updated to indicate the logical address 1, where a newly created free page exists.

In other embodiments, a distributed logging technique can be used.

In the distributed logging method, new values may be stored even in a page corresponding to an invalid logical address, so there is no need to frequently perform log cleaning operations.

Distributed logging is suitable when the size of a log entry is less than single page.

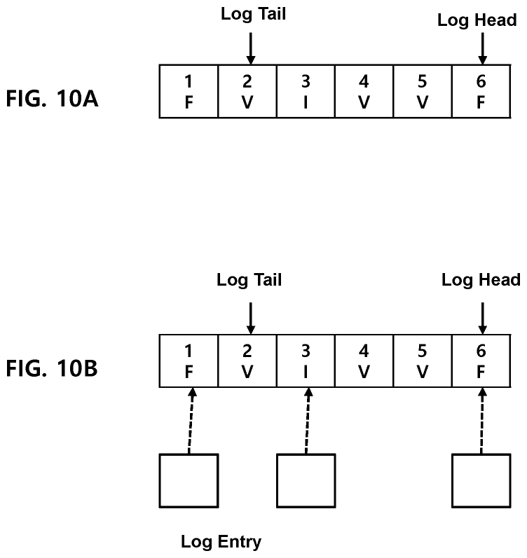

FIGS. 10A and 10B are diagrams illustrating a distributed logging operation according to an embodiment of the present disclosure.

In FIGS. 10A and 10B, numbers represent logical addresses, F represents a free page, I represents an invalid page, and V represent a valid page.

In distributed logging, a log entry may be recorded in a page corresponding to an invalidated logical address.

In the mapping table, physical pages corresponding to free or invalid logical addresses contain meaningless or no information.

In this embodiment, physical pages corresponding to free or invalid logical addresses are managed using a linked list.

Hereinafter, the linked list is referred to as a distributed logging linked list and physical pages corresponding to free or invalid logical addresses are referred to as distributed logging pages.

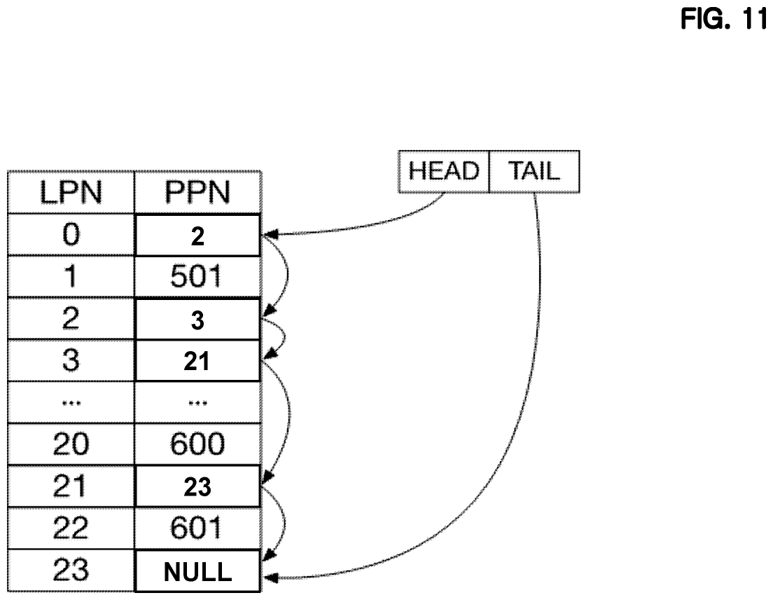

FIG. 11 is a diagram illustrating a method of managing a distributed logging linked list according to an embodiment of the present disclosure.

A head pointer HEAD points to a first distributed logging page, and a tail pointer TAIL points to a last distributed logging page.

A distributed logging page stores a logical page address or a logical page number LPN corresponding to the following distributed logging page number.

In FIG. 11, the first distributed logging page corresponds to a logical page number 0 and the last distributed logging page corresponds to LPN 23.

The physical page number (PPN) corresponding to LPN 0 is recorded as 2, which indicates an LPN for the next distributed logging page.

In this way, the distributed logging pages can be managed as a linked list.

In this embodiment, when a free or invalid page is added through a garbage collection operation, the tail pointer TAIL may be updated.

However, when the size of a log entry exceeds single page and when there are no continuous distributed logging pages, log cleaning operation is necessary.

The distributed logging linked list may be controlled by the first control circuit 100.

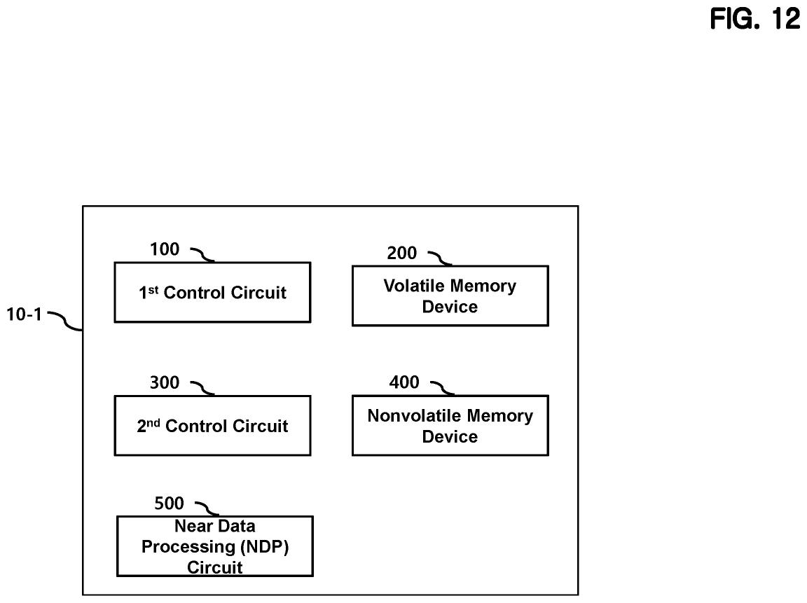

FIG. 12 is a block diagram showing a data storage device 10-1 according to an embodiment of the present disclosure.

The data storage device 10-1 supports a near data processing (NDP) operation.

The data storage device 10-1 is substantially the same as the data storage device 10 in FIG. 1, except that the data storage device 10-1 further includes an NDP circuit 500.

Although the NDP circuit 500 is illustrated as a separate element with respect to the first control circuit 100, the NDP circuit 500 may be included in the first control circuit 100.

In this embodiment, an execution code for an NDP operation may be stored in the data storage device 10-1 in advance through a KV command.

This may be performed through a PUT command, wherein a key designated by a PUT command corresponds to an identification number of a program and a value corresponds to an execution code.

An execution code can be processed in the NDP circuit 500.

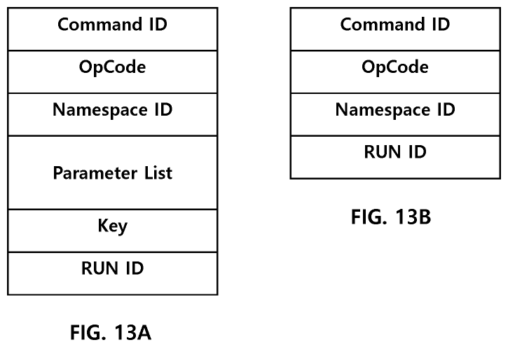

FIGS. 13A and 13B are diagrams showing KV commands for NDP operations.

FIG. 13A corresponds to an EXECUTE command and FIG. 13B corresponds to a STATUS command.

The EXECUTE command and the STATUS command can be implemented by conforming to the NVMe protocol like the other KV commands shown in FIGS. 2A to 2C.

In these commands, the RUN ID field stores information for identifying a type of a command to be executed, and the Parameter list field stores parameters to be used in an execution code.

When receiving an EXECUTE command, the first control circuit 100 reads a corresponding execution code.

This is practically the same as processing a GET command.

The execution code may be processed in the NDP circuit 500 along with parameters included in the EXECUTE command, and its status and results may be provided to the first control circuit 100.

When the first control circuit 100 receives the STATUS command, the NDP circuit 500 queries processing status of an execution code corresponding to a RUN ID.

The processing status may be one of WAITING, RUNNING, or EXITED.

WAITING indicates a state before running an execution code, RUNNING indicates a state in which the execution code is being executed and EXITED indicates a state in which running of an execution code has been completed and result thereof has been provided.

Different structures of an execution code are possible, and accordingly, structure of the NDP circuit 500 for running an execution code can be different depending on the structure of the execution code.

As described above, since embodiments operate without relying on a file system, a process of converting a file address to a logical address through a file system is unnecessary during an NDP operation, so that a faster operation can be performed.

Although various embodiments have been illustrated and described, various changes and modifications may be made to the described embodiments without departing from the spirit and scope of the invention as defined by the following claims.

What is claimed is:

1. A data storage device comprising:
a nonvolatile memory device including a key storage area and a value storage area; and
a first control circuit configured to control storing a value in the value storage area and storing a key with address information of the stored value in the key storage area, according to a key-value (KV) command.

2. The data storage device of claim 1,
further comprising a volatile memory device including an area for storing a key,
wherein when a KV command is received, the first control circuit searches the volatile memory device to determine whether a key in the KV command exists, and
wherein when the key in the KV command does not exist in the volatile memory device, the first control circuit further searches the nonvolatile memory device to determine whether the key in the KV command exists.

3. The data storage device of claim 2,
wherein the volatile memory device stores a first table and the nonvolatile memory device stores a second table, and
wherein each of the first table and the second table includes:
a data area for storing a plurality of address information of values stored in the value storage area; and
an index area for storing a plurality of pairs each having a key and an offset of address information stored in the data area.

4. The data storage device of claim 3, wherein each of the first table and the second table further includes a filter area storing filter data for determining whether a key exists in the index area.

5. The data storage device of claim 4, wherein the first control circuit manages the second table so that the second table is stored according to a data structure of a Log-Structured Merge (LSM) tree.

6. The data storage device of claim 1, wherein the value storage area in the nonvolatile memory device stores a plurality of log entries, and each of the log entries includes a value and a length of the corresponding value.

7. The data storage device of claim 6,
further comprising a mapping table for storing relationships between a logical address and a physical address of the nonvolatile memory device,
wherein the first control circuit manages a distributed logging linked list storing a logical address for a free page or an invalid page, and
wherein the first control circuit uses a logical page in the distributed logging linked list when a log entry is added.

8. The data storage device of claim 7,
further comprising a second control circuit configured to perform a garbage collection operation on the nonvolatile memory device,
wherein the first control circuit updates the distributed logging linked list when a garbage collection operation is performed.

9. The data storage device of claim 1,
further comprising a near data processing (NDP) circuit configured to execute an execution code and to generate a result,
wherein when the KV command is an NDP command, the first control circuit provides the NDP circuit with the execution code extracted from the value corresponding to the key.

10. The data storage device of claim 9, wherein the NDP command further includes a parameter, and the first control circuit provides the parameter to the NDP circuit.

11. A system comprising:
a host configured to generate a key-value (KV) command;
a data storage device configured to perform a read or a write operation according to the KV command; and
an interface circuit configured to transfer the KV command between the host and the data storage device,
wherein the data storage device includes:
a nonvolatile memory device including a key storage area and a value storage area; and
a first control circuit configured to control storing a value in the value storage area and storing a key with address information of the stored value in the key storage area, according to the KV command.

12. The system of claim 11,
wherein the data storage device further includes a volatile memory device including an area for storing a key,
wherein when a KV command is received, the first control circuit searches the volatile memory device to determine whether a key in the KV command exists, and
wherein when the key in the KV command does not exist in the volatile memory device, the first control circuit further searches the nonvolatile memory device to determine whether the key in the KV command exists.

13. The system of claim 12,
wherein the volatile memory device stores a first table and the nonvolatile memory device stores a second table, and
wherein each of the first table and the second table includes:
a data area for storing a plurality of address information of values stored in the value storage area; and
an index area for storing a plurality of pairs each having a key and an offset of address information stored in the data area.

14. The system of claim 13, wherein each of the first table and the second table further includes a filter area for determining whether a key exists in the index area.

15. The system of claim 14, wherein the first control circuit manages the second table so that the second table is stored according to a data structure of a Log-Structured Merge (LSM) tree.

16. The system of claim 11, wherein the value storage area in the nonvolatile memory device stores a plurality of log entries, and each of the log entries includes a value and a length of the corresponding value.

17. The system of claim 16,
wherein the data storage device further includes a mapping table for storing relationships between a logical address and a physical address of the nonvolatile memory device,
wherein the first control circuit manages a distributed logging linked list storing a logical address for a free page or an invalid page, and
wherein the first control circuit uses a logical page in the distributed logging linked list when a log entry is added.

18. The system of claim 17,
wherein the data storage device further includes a second control circuit configured to perform a garbage collection operation on the nonvolatile memory device, and
wherein the first control circuit updates the distributed logging linked list when a garbage collection operation is performed.

19. The system of claim 11,
wherein the data storage device further includes a near data processing (NDP) circuit configured to execute an execution code and to generate a result, and
wherein when the KV command is an NDP command, the first control circuit provides the NDP circuit with the execution code extracted from the value corresponding to the key.

20. The system of claim 19, wherein the NDP command further includes a parameter, and the first control circuit provides the parameter to the NDP circuit.

21. The system of claim 11, wherein the host comprises:
an application program processing circuit configured to process an application program requesting a read or a write operation for a value corresponding to a key; and
a KV device control circuit configured to generate the KV command corresponding to the request and to provide the KV command to the data storage device via the interface circuit.

22. A data processing system comprising:
a host suitable for providing a command related to a key and a value pair, the command conforming to a protocol for communication with a nonvolatile memory system; and
the nonvolatile memory system including:
a nonvolatile storage device including first to third storages; and
a controller suitable for controlling the nonvolatile storage device to perform a nonvolatile storage operation for the key and the value,
wherein the controller controls, in response to a put command provided together with the pair, the nonvolatile storage device to store in units of pages:
in the first storage, the pair;
in the second storage, one or more tables each having a first list of offset information indicating the stored pair, a second list of a pair of the key and an indicator for the offset information and a bloom filter for the second list; and
in the third storage, at least location information of the stored tables and indicators for storage locations for the pair and the table to be respectively stored in the first and second storages, and
wherein the controller controls, in response to a get command provided with the key for the stored value, the nonvolatile storage device to:
detecting the offset information from the second storage based on the key provided with the get command; and
retrieving the value from the first storage based on the detected offset information.
